(19) United States
(12) Patent Application Publication
(10) Pub. No.: US 2015/0324414 A1
(43) Pub. Date: Nov. 12, 2015

(54) INFORMATION PROCESSING DEVICE AND INFORMATION PROCESSING METHOD

(71) Applicant: Masao NOGUCHI, (US)

(72) Inventor: Masao NOGUCHI, Tokyo (JP)

(73) Assignee: MITSUBISHI ELECTRIC CORPORATION, Tokyo (JP)

(21) Appl. No.: 14/388,303

(22) PCT Filed: Nov. 28, 2012
(86) PCT No.: PCT/JP2012/080712

§ 371 Date: Sep. 26, 2014

(30) Foreign Application Priority Data
Mar. 29, 2012 (JP) 2012-075776

(51) Int. Cl. G06F 17/30

(52) U.S. Cl. CPC G06F 17/30368; G06F 17/30091; G06F 17/30106

(57) ABSTRACT

A data storage unit (111) which stores attribute management information for managing attribute information of a content file included in data recorded on a recording medium which has been used previously and medium management information including partial medium identification information designated in each predetermined part by at least one of a content file placed immediately under a layer formed in the data recorded on the recording medium and a layer, a medium identification information comparison unit (107) which compares partial medium identification information generated from data of the recording medium which is going to be used and the partial medium identification included in the medium management information, and a tag management information update unit (113) which updates the attribute information partially when a result of the comparison indicates disagreement are included.

### TECHNICAL FIELD

The present invention relates to information processing devices and information processing methods.

### BACKGROUND ART

Recent prevalence of audio compression techniques such as MP3 (MPEG Audio Layer-3), video compression techniques such as H.264/MPEG-4 AVC, and recording media such as CD-R, DVD-R, USB memories, SD memory cards, and mobile terminals, has increased the number of cases in which individuals take out their own favorite video content files and music content files from their home and enjoy those contents in their vehicles and the like, for example. To satisfy the requests for use like this, an increasing number of in-vehicle reproduction apparatuses, for example, have a USB (Universal Serial Bus) interface for connecting a USB memory or mobile terminal and a card slot for an SD memory card and the like to read a content file stored in a recording medium and to reproduce the content.

Those portable recording media such as USB memories, SD memory cards, and flash memories have increased in the recording capacities to enable thousands to tens of thousands of content files to be stored, for example.

If a single recording medium includes a large number of content files, in order that a user may select desired audio or video files and enjoy them quickly, it becomes very important for user's convenience to display a selection list of attribute information (tag information) such as content title names, artist names, and album names and to reproduce contents in a user-selected order.

Generally, most of content files can contain content tag information such as content title names, artist names, and album names in their content files themselves. An MP3 file, which is one of compression formats of music file, for example, can store the tag information in an ID3 tag format within the MP3 file. By using the tag information, a content selection list can be displayed in a highly-user-friendly form such as a listing by artist name, and the contents can also be reproduced in order of artist names and in order of album names.

As the tag information, however, is stored in each content file, in order to obtain necessary information, it is necessary to open each content file and to analyze the tag information. The process of extracting the tag information from thousands to tens of thousands of content files accordingly has a very heavy processing load, so a problem that the user cannot use the content selection list immediately after selecting a recording medium is induced.

To cope with the problem, for example, patent reference 1 discloses a content reproduction apparatus that generates a title list file associating file information and tag information extracted from content files and records the title list file on a recording medium such as an USB memory. The content reproduction apparatus disclosed in patent reference 1 generates identification information by combining the identification information of a content file and sort-identification information including a string extracted from the tag information of the content file, and lists the identification information successively in a list file in ascending order of sort-identification information. The content reproduction apparatus stores the list file in the USB memory in which user's content files are stored. The content reproduction apparatus can then successively reproduce contents by reading out the list file from the USB memory and the content files in the order in which they are listed in the list file.

When contents are reproduced, the content reproduction apparatus disclosed in patent reference 1 creates the list file and writes it into the USB memory, and also writes the specific ID of the apparatus at the same time in the first part of the list. When using the list file, the content reproduction apparatus first checks whether the specific ID of the apparatus is correct or not; if the ID is correct, the apparatus compares the total number of files listed in the list file with the total number of actual files written in the USB memory. If the total numbers of files are equal, the content reproduction apparatus determines that the list file has the latest state and reproduces contents in the order indicated by the title list included in the list file.

### PRIOR ART REFERENCES

### Patent Reference

Patent reference 1: JP 2008-21349 (Page 21, FIGS. 5 and 6)

### SUMMARY OF THE INVENTION

### Problems to be Solved by the Invention

The art disclosed in patent reference 1, however, has such a problem that since just the apparatus ID and the total number of files contained in the list file are used to check validity of the list file, a misjudgment can occur. For example, when an album stored in a recording medium is rewritten to another album, if the deleted album and the newly stored album have the same number of content files, the content reproduction apparatus disclosed in patent reference 1 could not recognize the fact that the contents have been rewritten because the total number of files has not been changed. The newly added album would be reproduced in the reproduction order of the deleted album. In that case, the content reproduction apparatus should determine that the list file is invalid, or does not reflect the latest state, and generate a new list file again. For example, the number of tunes stored in commercial CD albums is generally set to around 10 to 15 tunes per album, so a possibility that a replaced album has the same number of tunes is high.

An object of the present invention is to determine correctly whether contents in a recording medium have been rewritten and to use efficiently content attribute information obtained beforehand.

### Means for Solving the Problem

An information processing device in one aspect of the present invention includes a data storage unit which stores attribute management information for managing attribute information of a content file included in data recorded on a recording medium which has been used previously and, for each predetermined part, medium management information including partial medium identification information identified by at least one of a layer and a content file placed immediately under a layer formed in the data recorded on the previously used recording medium; a data acquisition unit which acquires data from a recording medium which is used currently; a file information analysis unit which analyzes the data acquired by the data acquisition unit and generates entry management information which indicates a layer formed in the acquired data and at least one of a content file and a layer placed immediately under the layer formed in the acquired data; a medium identification information generation unit which generates, for each predetermined part, partial medium identification information identified by at least one of the content file and the layer placed immediately under the layer formed in the data acquired by the data acquisition unit, from the entry management information; a medium identification information comparison unit which compares the partial medium identification information included in the medium management information and the partial medium identification information generated by the medium identification information generation unit; and an attribute management information update unit which updates the attribute management information on the basis of the attribute information of the content file included in the predetermined part for which the medium identification information generation unit has generated the partial medium identification information determined as being not equal to the partial medium identification information stored in the data acquisition unit in accordance with a result of the comparison by the medium identification information comparison unit.

An information processing device in another aspect of the present invention includes a data storage unit which stores attribute management information for managing the attribute information of a content file included in data recorded on a recording medium which has been used previously and medium management information including general medium identification information identified by all layers formed in the data recorded in the previously used recording medium and content files placed immediately under all the layers; a data acquisition unit which acquires data from a recording medium which is used currently; a file information analysis unit which analyzes the data acquired by the data acquisition unit and generates entry management information which indicates a layer formed in the acquired data and at least one of a layer and a content file placed immediately under the layer formed in the acquired data; a medium identification information generation unit which generates general medium identification information identified by all the layers formed in the data acquired by the data acquisition unit and content files placed immediately under all the layers formed in the data acquired by the data acquisition unit, from the entry management information; and a medium identification information comparison unit which compares the general medium identification information included in the medium management information and the general medium identification information generated by the medium identification information generation unit.

### Effects of the Invention

In one aspect or another aspect of the present invention, whether the contents of a recording medium have been rewritten can be determined correctly, and the content attribute information obtained beforehand can be used efficiently.

### BRIEF DESCRIPTION OF THE DRAWINGS

FIG. 1 is a block diagram schematically showing a configuration of a reproduction apparatus according to a first embodiment.

FIG. 2 is a schematic diagram showing an example of a hierarchical structure of data in a recording medium in the first embodiment.

FIG. 3 is a schematic diagram showing an example of entry management information 140 in the first embodiment.

FIGS. 4A to 4D are schematic diagrams showing an example of tag management information in the first embodiment.

FIG. 5 is a schematic diagram showing an example of medium management information in the first embodiment.

FIG. 6 is a schematic diagram showing ranges of entries used when medium identification information is generated in the first embodiment.

FIG. 7 is a flowchart (part 1) illustrating a process to be performed when a recording medium is inserted in the first embodiment.

FIG. 8 is a flowchart (part 2) illustrating a process to be performed when a recording medium is inserted in the first embodiment.

FIG. 9 is a block diagram schematically showing a configuration of a reproduction apparatus according to a second embodiment.

FIG. 10 is a schematic diagram showing information stored in a data storage unit in the second embodiment.

FIG. 11 is a flowchart illustrating a process to be performed to update a time management number in the second embodiment.

FIG. 12 is a flowchart illustrating a process to be performed to store data in the data storage unit in the second embodiment.

FIG. 13 is a block diagram schematically showing a configuration of a reproduction apparatus according to a third embodiment.

FIG. 14 is a schematic diagram showing ranges of entries used when fourth medium identification information is generated in the third embodiment.

### MODE FOR CARRYING OUT THE INVENTION

### First Embodiment

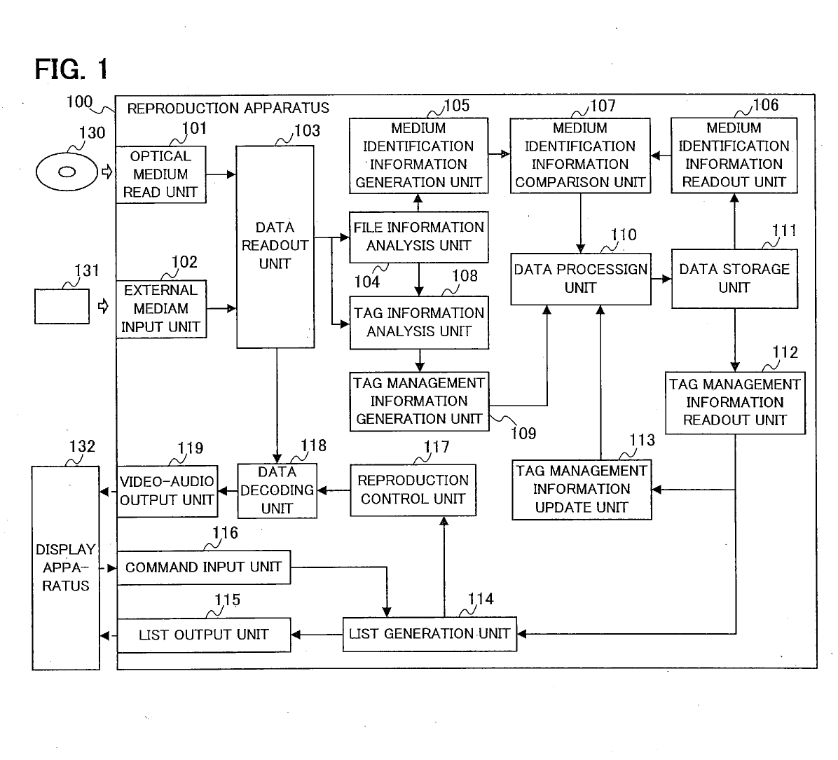

FIG. 1 is a block diagram schematically showing a configuration of a reproduction apparatus 100 as an information processing device according to a first embodiment. The reproduction apparatus 100 includes an optical medium read unit 101, an external medium input unit 102, a data readout unit 103, a file information analysis unit 104, a medium identification information generation unit 105, a medium identification information readout unit 106, a medium identification information comparison unit 107, a tag information analysis unit 108 as an attribute information analysis unit, a tag management information generation unit 109 as an attribute management information generation unit, a data processing unit 110, a data storage unit 111, a tag management information readout unit 112 as an attribute management information readout unit, a tag management information update unit 113 as an attribute management information update unit, a list generation unit 114, a list output unit 115, a command input unit 116, a reproduction control unit 117, a data decoding unit 118, and a video-audio output unit 119.

In FIG. 1, among units included in the reproduction apparatus 100 or units directly connected to the reproduction apparatus 100, units that are not directly related to features of this embodiment (for example, a temporary data storage unit for storing data temporarily in a video and audio decoding process) are omitted.

The optical medium read unit 101 reads data from an optical medium 130, which may be a CD, DVD, or BD commercially available as a package medium or a CD-R, DVD-R, BD-R or the like, on which contents are written in a format such as MP3 by a user. The optical medium read unit 101 supplies the read data to the data readout unit 103.

The external medium input unit 102 reads data from an external medium 131. The external medium 131 may be a USB memory, an SD memory card, or a memory in a mobile terminal. The external medium input unit 102 may be configured by a USB interface, a card reader for flash media such as the SD memory card, and the like. The external medium input unit 102 supplies the read data to the data readout unit 103.

The data readout unit 103 controls the optical medium read unit 101 and the external medium input unit 102 to perform a process of reading data from the recording medium by using them.

The optical medium read unit 101, external medium input unit 102, and data readout unit 103 form a data acquisition unit for acquiring data from the recording medium.

The file information analysis unit 104 analyzes a hierarchical structure (file information) of data in the recording medium when the recording medium such as the optical medium 130 and the external medium 131 is set readable, for example, when the optical medium 130 is inserted into the optical medium read unit 101 or when the external medium 131 is inserted into the external medium input unit 102. For example, the file information analysis unit 104 analyzes the hierarchical structure by detecting a folder forming each layer and a file and a folder (layer) that are included immediately under the detected folder. As for the files, their update date and time are also detected. The hierarchical structure can be analyzed easily from the management information of the file system.

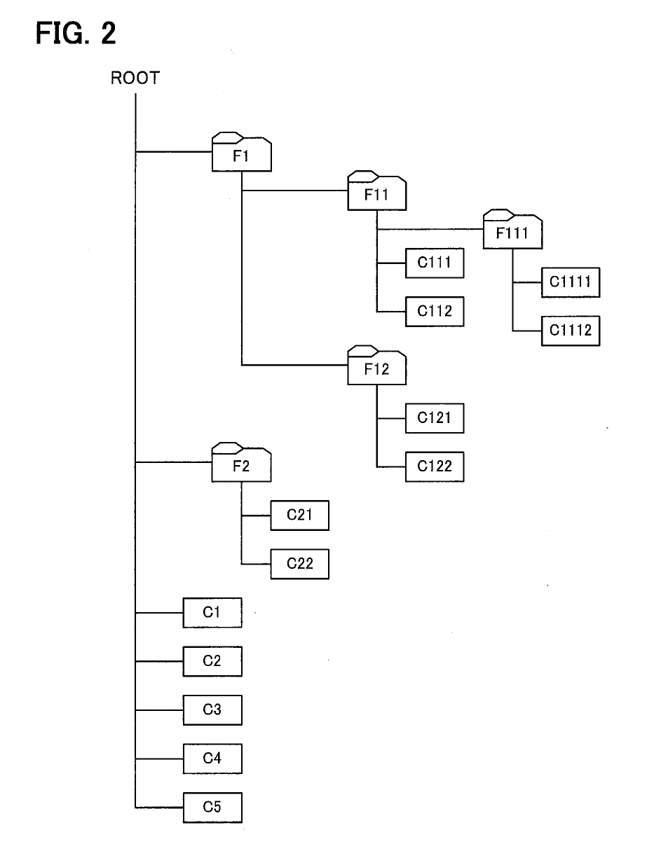

FIG. 2 is a schematic diagram showing an example of the hierarchical structure of the data in the recording medium. In this recording medium, five content files denoted by reference characters C1 to C5 are stored immediately under the root. These content files are MP3 format music files, avi format video files, or the like, for example. Besides these five content files, two folders denoted by reference characters F1 and F2 are provided immediately under the root. Two content files denoted by reference characters C21 and C22 are stored immediately under folder F2. Two subfolders, which are folders F11 and F12, are provided immediately under folder F1. Two content files denoted by reference characters C121 and C122 are stored immediately under folder F12. Two content files C111 and C112 are stored immediately under folder F11 and folder F111, which is a subfolder, is provided immediately under folder F11. Two content files denoted by reference characters C1111 and C1112 are stored immediately under folder F111.

Referring to FIG. 1 again, the file information analysis unit 104 generates entry management information on the basis of the analyzed hierarchical structure.

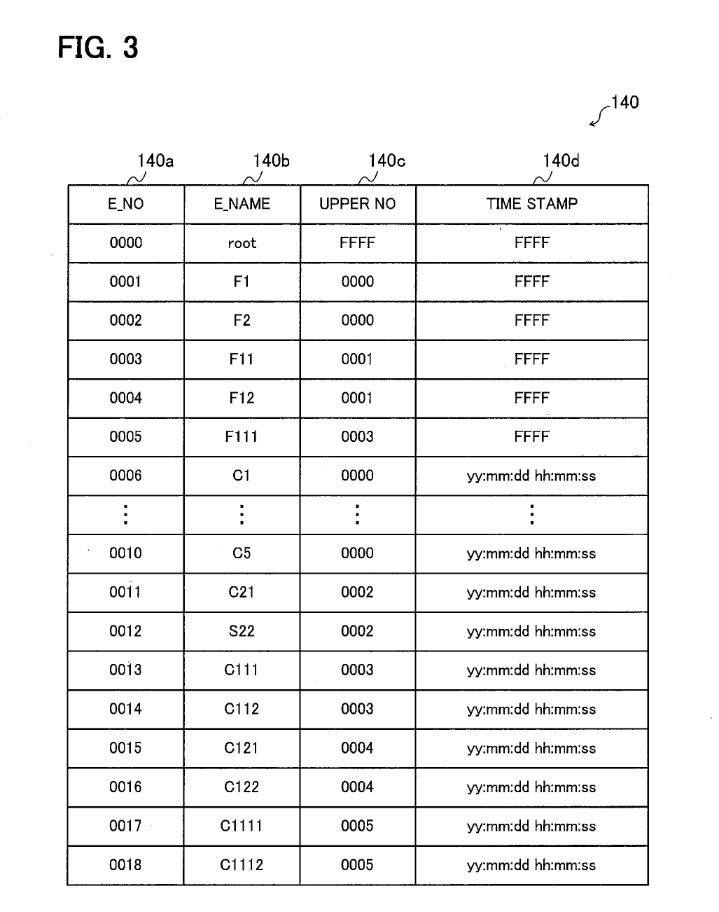

FIG. 3 is a schematic diagram showing an example of entry management information 140. The entry management information 140 is tabular form information including an E_No column 140a, an E_Name column 140b, an UpperNo column 140c, and a TimeStamp column 140d.

The E_No column 140a stores an entry number as unique identification information assigned to a file and folder.

The E_Name column 140b stores a file name and folder name as identification information (name) for identifying the file and folder.

The UpperNo column 140c stores an entry number which is the identification information of the folder corresponding to a layer that is one layer higher than the entry (file or folder) identified by E_No column 140a. If the entry identified by the E_No column 140a is the root (root folder), a predetermined value, such as ‘FFFF’, is stored.

The TimeStamp column 140d stores the update date and time of the entry identified by the E_No column 140a. If the entry identified by the E_No column 140a is a folder, a predetermined value, such as ‘FFFF’, is stored.

The entry management information 140 will now be described in detail on the basis of the hierarchical structure in the recording medium shown in FIG. 2.

In the E_Name column 140b, folder names are sorted by their names and stored, and then file names are sorted by their names and stored. The sorting method is not limited particularly, but for example, it may be performed alphabetically.

If the entry is a root, an entry number ‘0000’ is stored in the E_No column 140a; the name ‘root’ is stored in the E_Name column 140b; ‘FFFF’ indicating that there is no upper layer is stored in the UpperNo column 140c; and ‘FFFF’ allocated to the folder is stored in the TimeStamp column 140d.

The entry having ‘0001’ in the E_No column 140a is folder F1. The folder name ‘F1’ is stored in the E_Name column 140b, and the entry number ‘0000’ of the root as the parent folder of folder F1 is stored in the UpperNo column 140c. ‘FFFF’ is stored in the TimeStamp column 140d. In the same way as above, the other folder entries are stored in order of name.

The entry having ‘0006’ in the E_No column 140a is file C1. The file name ‘C1’ is stored in the E_Name column 140b, and the entry number ‘0000’ of the root as the parent folder of file C1 is stored in the UpperNo column 140c. The date and time at which file C1 has been updated is stored in the TimeStamp column 140d. Thereafter, the corresponding information of each of the file entries having entry numbers 0007 to 0018 is stored in order in which they have been sorted by name.

Although the entry number ‘0000’ is assigned to the root in the example shown in FIG. 3, the number is not limited to that value. ‘FFFF’ is stored in the UpperNo column 140c of the highest root, but the value is not limited to that. The digit number of numerical value is not limited to the example shown in FIG. 3 and may be determined as required on the basis of the number of content files to be handled by the reproduction apparatus 100.

Referring to FIG. 1 again, the tag information analysis unit 108 analyzes tag information used as content attribute information, from the data read by the data readout unit 103. For example, if a music file is compressed in the MP3 format, ID3 tag information can be embedded in the content file. The tag information in the MP3 file contains items such as title information, artist information, album information, genre information, and so on. The tag information analysis unit 108 successively analyzes the tag information of the content files stored in the recording medium on the basis of the hierarchical structure analyzed by the file information analysis unit 104. As a result of the analysis, the tag information analysis unit 108 generates analysis result information indicating the tag information for each content file, for example. The tag information analysis unit 108 supplies the analysis result to the tag management information generation unit 109.

The tag management information generation unit 109 generates tag management information (attribute management information) for managing the tag information of content files in accordance with the analysis result by the tag information analysis unit 108. The tag management information associates, for example, a content file with the tag information included in the content file. When necessary information is held in the tag management information in accordance with the analysis result of all the content files, the tag management information generation unit 109 supplies the tag management information to the data processing unit 110.

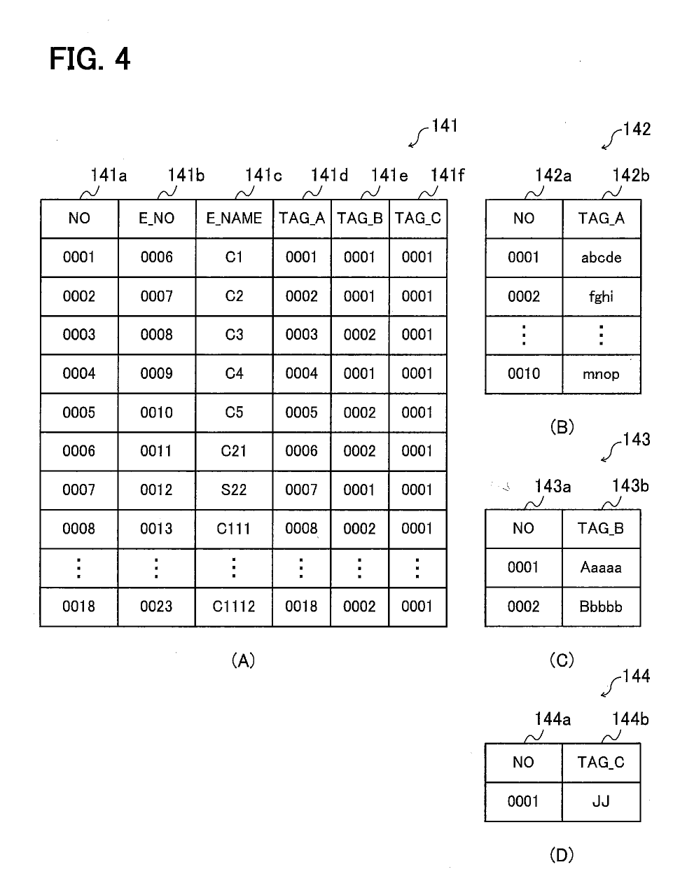

FIGS. 4A to 4D are schematic diagrams showing an example of the tag management information. The tag management information includes master management information 141 shown in FIG. 4A and item management information 142 to 144 shown in FIGS. 4B, 4C, and 4D. The master management information 141 associates contents files and information stored in the item management information 142 to 144. The item management information 142 to 144 respectively holds information corresponding a single item of the tag information.

FIG. 4A is a schematic diagram showing an example of the master management information 141. The master management information 141 has a No column 141a, an E_No column 141b, an E_Name column 141c, a Tag_A column 141d, a Tag_B column 141e, and a Tag_C column 141f.

The No column 141a stores an identification number as identification information for identifying each record of the master management information 141.

The E_No column 141b stores an entry number as identification information uniquely assigned to a content file. For a single content file, the entry number stored in the E_No column 141b and the entry number stored in the E_No column 141a of the entry management information 140 are equal.

The E_Name column 141c stores a file name as identification information (name) for identifying the content file. For a single content file, the file name stored in the E_Name column 141c and the file name stored in the E_No column 141b of the entry management information 140 are equal.

The Tag_A column 141d stores first item identification information for identifying the information of a first item of the tag information stored in the first item management information 142.

The Tag_B column 141e stores second item identification information for identifying the information of a second item of the tag information stored in the second item management information 143.

The Tag_C column 141f stores third item identification information for identifying the information of a third item of the tag information stored in the third item management information 144.

FIG. 4B is a schematic diagram showing an example of the first item management information 142. The first item management information 142 is table format information including a No column 142a and a Tag_A column 142b.

The No column 142a stores first item identification information for identifying the information of a first item of the tag information to be stored in the Tag_A column 142b.

The Tag_A column 142b stores the information of the first item of the tag information. The information of the first item of the tag information is title information (title name) of the content, for example, but the information of the item is not limited to that information.

FIG. 4C is a schematic diagram showing an example of the second item management information 143. The second item management information 143 is table format information including a No column 143a and a Tag_B column 143b, but is not limited to that.

The No column 143a stores second item identification information for identifying the information of a second item of the tag information to be stored in the Tag_B column 143b.

The Tag_B column 143b stores the information of the second item of the tag information. The information of the second item of the tag information is artist information (artist name) of the content, for example, but the information of the item is not limited to that information.

FIG. 4D is a schematic diagram showing an example of the third item management information 144. The third item management information 144 is table format information including a No column 144a and a Tag_C column 144b.

The No column 144a stores third item identification information for identifying the information of a third item of the tag information to be stored in the TagC column 144b.

The Tag_C column 144b stores information of the third item of the tag information. For example, the information of the third item of the tag information is genre information (genre name) of the content, but the information of the item is not limited to that information.

In the item management information 142 to 144, a single piece of item identification information is assigned to a single piece of information; duplicate pieces of information are integrated into a single piece of information. For example, when three tunes in the recording medium have the same song title (title name) ‘sakura’, three corresponding records of ‘sakura’ are not formed in the first item management information 142; just a single record of ‘sakura’ is formed.

The master management information 141 shown in FIG. 4A associates a content file with the information of items included in the tag information. For example, The Tag_A column 141d indicates that the content file identified by ‘0006’ in the E_No column 141b has the first item identification information ‘0001’, that is information ‘abcde’ shown in FIG. 4B, as its tag information. Besides, the Tag_B column 141e indicates that the content file has the second item identification information ‘0001’, that is information ‘Aaaaa’ in FIG. 4C, as its tag information. The Tag_C column 141f indicates further that the content file has the third item identification information ‘0001’, that is information ‘JJ’ in FIG. 4D, as its tag information.

When a plurality of content files are present in a recording medium, those content files quite often have common tag information except the song title. If an album has 12 tunes, for example, an album name would be a common item for the twelve content files. Since the genre is categorized as pop, rock and others, it is a common item for greater numbers of content files. For this reason, by generating the tag management information in separate parts, such as the item management information 142 to 144 and the master management information 141 described above, effects of the present invention can be produced with a smaller memory capacity.

In the example shown in FIG. 4, the information of the tag information is managed with three pieces of item management information, which are the first item management information 142, the second item management information 143, and the third item management information 144, but the number of pieces of the item management information is not limited to three. For example, by adding another piece of item management information holding an album name, the tag management information may contain four pieces of item management information. If the genre information is unnecessary, the corresponding piece of item management information may be eliminated, and the tag management information may contain two pieces of item management information. If the number of pieces of item management information is increased or decreased, the number of columns in the master management information 141 should be increased or decreased accordingly.

Referring to FIG. 1 again, the data processing unit 110 has the data storage unit 111 record the tag management information generated by the tag management information generation unit 109. The tag management information is associated with the entry management information 140 generated by the file information analysis unit 104.

As described later, the data processing unit 110 has the data storage unit 111 store medium management information generated by the medium identification information generation unit 105.

The data storage unit 111 stores the tag management information and medium management information in association with each other. The data storage unit 111 also stores the tag management information and medium management information generated or updated from the data recorded on a recording medium which has been used previously. The data storage unit 111 may store the entry management information 140 corresponding to the tag management information in addition to the tag management information. The data storage unit 111 may be configured by a nonvolatile memory, hard disk drive, and the like, and the stored information is retained even when the reproduction apparatus 100 is powered off.

The tag management information readout unit 112 reads the tag management information stored in the data storage unit 111.

The list generation unit 114 obtains the tag management information from the tag management information readout unit 112 and generates a selection list which is a list of the information of a specific item. For example, when input of a command from the user to select an item of tag information is received through the command input unit 116, the list generation unit 114 extracts the information of the selected item from the tag management information and generates a selection list indicating the extracted information. More specifically, if the user-selected item of tag information is an artist, for example, the list generation unit 114 obtains the second item management information 143 corresponding to the item of the artist from the tag management information readout unit 112. The list generation unit 114 then generates a selection list which is a list of the information (artist names) stored in the Tag_B column 143b of the second item management information 143. The list generation unit 114 supplies the generated selection list to the list output unit 115. The list generation unit 114 may then obtain title names (song titles) of content files having entry numbers included in the selection list from the tag management information and sort the information in the selection list by the title name according to a given rule. Any sorting method may be used here; the list generation unit 114 may sort the title names alphabetically, for example.

The list generation unit 114 further generates a reproduction list indicating content files corresponding to the information selected according to the selection list by the user. More specifically, if an artist name as the specific information is selected according to the selection list displayed on a display apparatus 132 by the user, for example, the list generation unit 114 obtains the user-selected artist name through the command input unit 116. The list generation unit 114 obtains the second item management information 143 from the tag management information readout unit 112, identifies a record having the selected artist name in the Tag_B column 143b among the second item management information 143, and obtains the second item identification information stored in the No column 143a of the identified record. Then, the list generation unit 114 identifies a record having the obtained second item identification information with reference to the Tag_B column 141e of the master management information 141 and identifies the entry number of the content file from the E_No column 141b of the identified record. The list generation unit 114 then generates a reproduction list indicating the identified entry number and supplies the reproduction list to the reproduction control unit 117. Here, the list generation unit 114 may obtain the title name (song title) of a content file having the entry number contained in the reproduction list from the tag management information and sort the information in the reproduction list by the title name according to a given rule. Any sorting method may be used here, and the list generation unit 114 may sort the title names alphabetically, for example.

The list output unit 115 generates a selection list screen showing the selection list supplied from the list generation unit 114 in a predetermined display form and outputs the selection list screen to the display apparatus 132, for example.

The command input unit 116 receives a command input from the user. For example, the command input unit 116 may receive a command input by the user on the display apparatus 132 connected to the reproduction apparatus 100 or may receive a command input by the user through a remote controller, not shown in the figure, or the like.

The reproduction control unit 117 controls the reproduction process by the reproduction apparatus 100. For example, when the reproduction list is obtained from the list output unit 115, the reproduction control unit 117 has the data readout unit 103 read content files having entry numbers included in the reproduction list.

The data decoding unit 118 decodes the content file read by the data readout unit 103 and supplies decoded video signal and audio signal to the video-audio output unit 119.

The video-audio output unit 119 outputs the video signal and audio signal supplied from the data decoding unit 118 to the display apparatus 132 connected to the reproduction apparatus 100, for example. The display apparatus 132 outputs video and audio in accordance with the video signal and audio signal.

The medium identification information generation unit 105 generates medium identification information for identifying a recording medium in accordance with the hierarchical structure analyzed by the file information analysis unit 104. The medium identification information generation unit 105 also generates medium management information for managing the generated medium identification information.

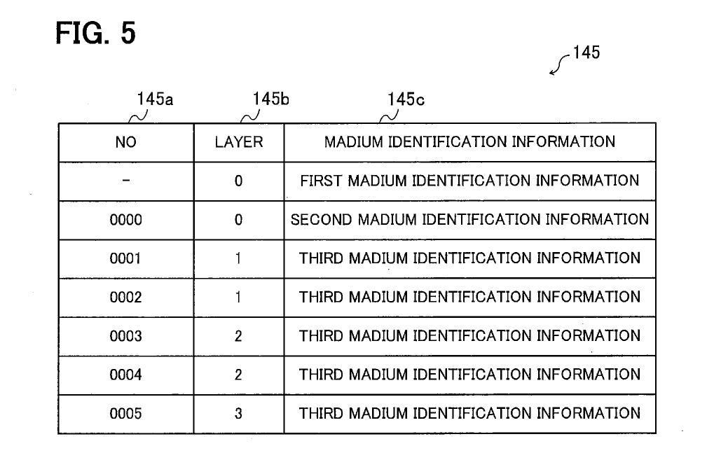

FIG. 5 is a schematic diagram showing an example of medium management information 145. The medium management information 145 is table format information including a No column 145a, a layer column 145b, and a medium identification information column 145c.

The No column 145a stores a record number as identification information for uniquely identifying medium identification information stored in the medium identification information column 145c.

The layer column 145b stores a layer of a folder from which the medium identification information stored in the medium identification information column 145c is calculated.

The medium identification information column 145c stores the medium identification information generated by the medium identification information generation unit 105. In this embodiment, the medium identification information includes first medium identification information, second medium identification information, and third medium identification information. The first medium identification information is general medium identification information identified by all layers formed in the data recorded on the recording medium and the content files placed immediately under all the layers. The second medium identification information and third medium identification information is partial medium identification information identified for predetermined part by at least one of a layer and a content file placed immediately under the layers formed in the data recorded on the recording medium. In the first embodiment, the predetermined parts for a specific layer are a part immediately under the specific layer and parts immediately under all the layers placed under the specific layer. The medium identification information is generated on the basis of the entry management information 140 generated by the file information analysis unit 104.

The first medium identification information will now be described. The first medium identification information is generated on the basis of the information stored in the E_Name column 140b, UpperNo column 140c, and TimeStamp column 140d of all entries of the entry management information 140. In this embodiment, the first medium identification information is a total value obtained by adding up each byte of the information stored in the E_Name column 140b, UpperNo column 140c, and TimeStamp column 140d of all the entries of the entry management information 140, as given by the expression (1) below.

ID1=Σ(E_Name[i]+TimeStamp[i]+UpperNo[i]) (1)

In the expression (1), E_Name[i] indicates the information stored in the E_Name column 140b of the entry corresponding to the entry number indicated by index i. TimeStamp[i] indicates information stored in the TimeStamp column 140d of the entry corresponding to the entry number indicated by index i. UpperNo[i] indicates information stored in the UpperNo column 140c of the entry corresponding to the entry number indicated by index i.

Next, the second medium identification information will now be described. The second medium identification information is generated on the basis of the information stored in the E_Name column 140b, UpperNo column 140c, and TimeStamp column 140d of all the entries corresponding to the content file stored immediately under the root in the entry management information 140. In this embodiment, the second medium identification is the total value obtained by adding up each byte of the information stored in the E_Name column 140b, UpperNo column 140c, and TimeStamp column 140d of all the entries corresponding to the content file stored immediately under the root in the entry management information 140, as given by the expression (2) below.

ID2=Σ(E_Name[j]+TimeStamp[j]+UpperNo[j]) (2)

In the expression (2), index j indicates the entry number of the content file stored immediately under the root. E_Name[j] indicates the information stored in the E_Name column 140b of the entry corresponding to the entry number indicated by the index j. TimeStamp[j] indicates the information stored in the TimeStamp column 140d of the entry corresponding to the entry number indicated by the index j. UpperNo[j] indicates the information stored in the UpperNo column 140c of the entry corresponding to the entry number indicated by the index j.

Next, the third medium identification information will now be described. The third medium identification information is generated on the basis of the information stored in the E_Name column 140b and TimeStamp column 140d of all the entries corresponding to folders and content files placed immediately under a folder designated as a starting point from among folders under the root and a folder placed in layers under the designated folder in the entry management information 140. In this embodiment, the third medium information is the total value obtained by adding up each byte of the information stored in the E_Name column 140b and TimeStamp column 140d of all the entries corresponding to folders and content files placed immediately under the designated folder and a folder placed in layers under the designated folder in the entry management information 140, as given by the expression (3) below.

ID3=Σ(E_Name[k]+TimeStamp[k]) (3)

In the expression (3), index k indicates the entry number of each entry corresponding to the folders and content files stored immediately under the designated folder and a folder placed in layers under the designated folder. E_Name[k] indicates the information stored in the E_Name column 140b of the entry corresponding to the entry number indicated by index k. TimeStamp[k] indicates information stored in the TimeStamp column 140d of the entry corresponding to the entry number indicated by index k.

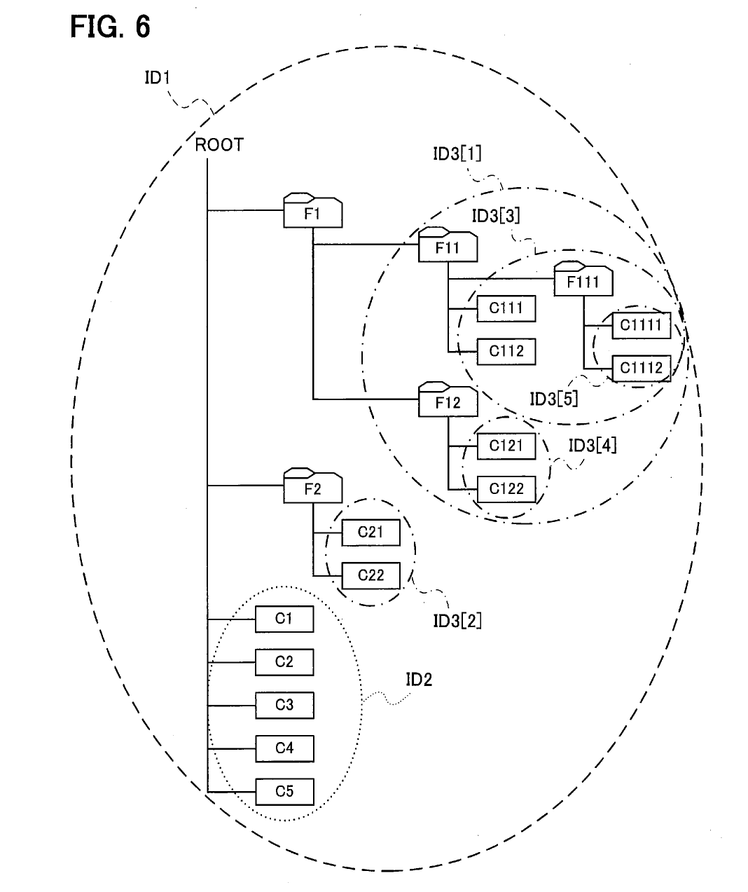

FIG. 6 is a schematic diagram showing ranges of entries used when the medium identification information is generated. First medium identification information ID1 is generated by using the information of all the entries stored in the entry management information 140. Second medium identification information ID2 is generated by using the information of content files C1 to C5 stored immediately under the root. Third medium identification information ID3[1] is generated by using the information of all entries included under folder F1 having entry number 0001: the used entries are folder F11, content file C111, content file C112, folder F12, content file C121, content file C122, folder F111, content file C1111, and content file C112. Third medium identification information ID3[2] is generated by using all the entries included under folder F2 having entry number 0002: the used entries are content file C21 and content file C22. Third medium identification information ID3[3] is generate by using all the entries included under folder F11 having entry number 0003: the used entries are content file C111, content file C112, folder F111, content file C1111, and content file C1112. As the same way described above, third medium identification information ID3[4] and ID3[5] is generated by using the information of the entries included under corresponding folders F11, F12, F111 which are designated as the starting points.

Referring to FIG. 1 again, the medium management information 145 generated as described above is supplied to the medium identification information comparison unit 107. The medium identification information comparison unit 107 has the data storage unit 111 store the medium management information 145, through the data processing unit 110.

The medium identification information readout unit 106 reads the medium management information 145 which has been generated previously and stored in the data storage unit 111 and supplies it to the medium identification information comparison unit 107.

The medium identification information comparison unit 107 compares the medium identification information included in the newly generated medium management information 145 which has been supplied from the medium identification information generation unit 105 and the medium identification information included in the previously generated medium management information 145 which has been supplied from the medium identification information readout unit 106, to determine whether or not they agree with each other.

For example, the medium identification information comparison unit 107 first compares the first medium identification information; if the agreement occurs, a previously used recording medium is inserted again into the reproduction apparatus 100 without changing the recorded content files, so it can be determined that the tag management information stored in the data storage unit 111 is valid. In this case, the list generation unit 114 can generate a reproduction list by reading the tag management information recorded in the data storage unit 111. Accordingly, the list generation unit 114 can quickly show a selection list to the user and supply a reproduction list to the reproduction control unit 117 without the tag information analysis unit 108 analyzing the tag information.

Next, if the agreement does not occur as a result of the comparison of the first medium identification information, the medium identification information comparison unit 107 compares the second medium identification information. If agreement occurs as a result of the comparison of the second medium identification information, it can be determined that the content files stored immediately under the root are unchanged.

The medium identification information comparison unit 107 further compares the third medium identification information. The third medium identification information is compared successively in descending order of layer, in other words, the closer the folder designated as the starting point is to the root, the earlier the third medium identification information is compared. By doing this, if agreement occurs as a result of the comparison of the third medium identification information, it can be determined that the configuration of the content files and folders under the starting folder has not been changed, and a position of change can be found easily.

If the medium identification information comparison unit 107 determines that the second medium identification information or the third medium identification information, or both do not match, the tag management information update unit 113 analyzes again the tag information of a content file placed immediately under the folder which is designated as the starting point for the medium identification information that does not match. The tag management information update unit 113 then performs a process to update the tag management information on the basis of the result of the analysis.

For example, when a recording medium having data recorded in the hierarchical structure as shown in FIG. 2 is inserted into the reproduction apparatus 100 for the first time, no medium identification information is coincident and it is recognized that the recording medium is inserted for the first time; so the tag information analysis unit 108 analyzes the tag information and the tag management information generation unit 109 generates tag management information and has the data storage unit 111 record it through the data processing unit 110. When the recording medium is removed and inserted again without rewriting any files, the medium identification information generation unit 105 generates the medium management information 145 on the basis of the result of analysis by the file information analysis unit 104. The medium identification information comparison unit 107 then compares the first medium identification information of the newly generated medium management information 145 and the first medium identification information ID of the previously generated medium management information 145 and determines that the two pieces are equal. The list generation unit 114 accordingly determines that the tag management information recorded in the data storage unit 111 is in the latest state, reads the tag management information, and generates a selection list and a reproduction list. The reproduction control unit 117 reproduces contents in accordance with the generated reproduction list.

If part of content files recorded on the recording medium is changed, for example, if content file C112 shown in FIG. 6 is deleted, the first medium identification information ID1 does not match, but the second medium identification information ID2 matches. The third medium identification information ID3[1] generated by designating folder F1 as the starting point does not match, but the third medium identification information ID3[2] generated by designating folder F2 as the starting point matches. The third medium identification information ID3[3] generated by designating folder F11 as the starting point does not match, but the third medium identification information ID3[4] generated by designating folder F12 as the starting point matches. The third medium identification information ID3[5] generated by designating folder F111 as the starting point matches. Therefore, the tag management information update unit 113 obtains tag information from the content files stored immediately under folder F11, analyzes the tag information, and updates the tag management information.

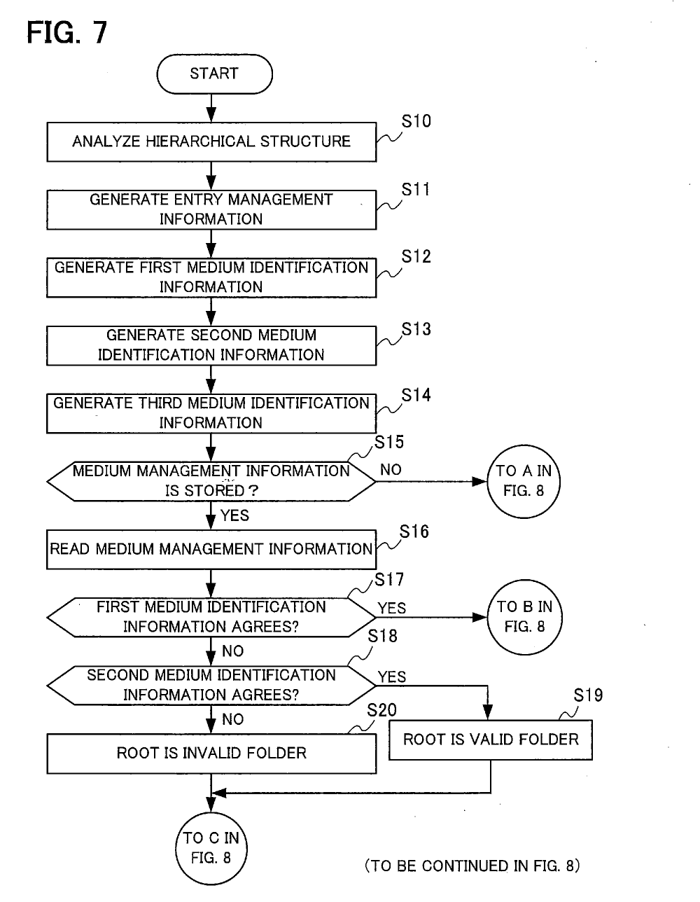

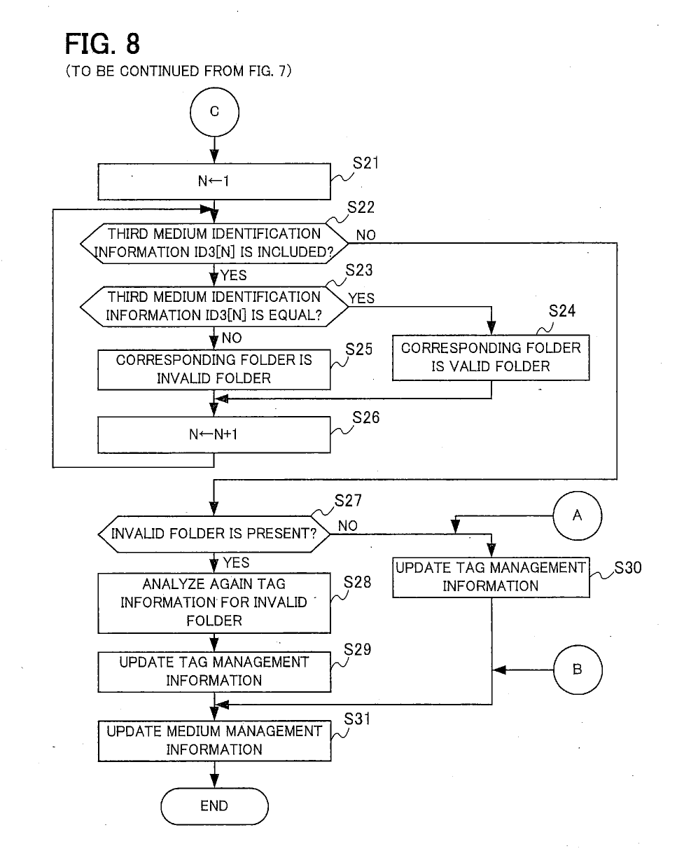

FIGS. 7 and 8 are flowcharts illustrating a process to be performed when a recording medium is inserted on the condition that the previous medium management information 145 is stored.

First, the file information analysis unit 104 analyzes the hierarchical structure on the basis of the data readout unit 103 has read from the recording medium (S10), and generates entry management information 140 (see FIG. 3) on the basis of the result of the analysis (S11).

Next, on the basis of the entry management information 140 generated by the file information analysis unit 104, the medium identification information generation unit 105 generates the first medium identification information (S12), the second medium identification information (S13), and the third medium identification information (S14). After generating the medium identification information, the medium identification information generation unit 105 generates the medium management information (see FIG. 5) including the medium identification information.

Next, the medium identification information readout unit 106 checks whether or not the data storage unit 111 stores the medium management information 145 which has been previously generated (S15). If no such medium management information 145 is stored (S15: No), the medium identification information readout unit 106 proceeds to step S30 in FIG. 8, and if such medium management information 145 is stored (S15: Yes), it proceeds to step S16.

In step S16, the medium identification information readout unit 106 reads the medium management information 145 that has been previously generated and stored in the data storage unit 111, and supplies the read medium management information 145 to the medium identification information comparison unit 107.

Next, the medium identification information comparison unit 107 checks whether or not the first medium identification information of the medium management information 145 supplied from the medium identification information generation unit 105 (hereafter referred to as new medium management information 145#1) and the first medium identification information of the medium management information 145 read by the medium identification information readout unit 106 (hereafter referred to as previous medium management information 145#2) agree with each other (S17). If they agree with each other (S17: Yes), the medium identification information comparison unit 107 determines that the tag management information stored in the data storage unit 111 is valid and proceeds to step S31 in FIG. 8, and if they do not agree (S17: No), it proceeds to step S18.

In step S18, the medium identification information comparison unit 107 checks whether or not the second medium identification information of the new medium management information 145#1 and the second medium identification information of the previous medium management information 145#2 agree with each other. If they agree with each other (S18: Yes), the medium identification information comparison unit 107 proceeds to step S19, and if they do not agree (S18: No), it proceeds to step S20.

In step S19, the medium identification information comparison unit 107 determines that the root is a valid folder and proceeds to step S21 in FIG. 8.

In step S20, the medium identification information comparison unit 107 determines that the root is an invalid folder and proceeds to step S21 in FIG. 8.

In step S21 in FIG. 8, the medium identification information comparison unit 107 initializes index n for identifying the third medium identification information of the new medium management information 145#1. It is assumed that natural numbers which consist of values obtained by adding ‘1’ one by one to an initial value ‘1’ are assigned as indexes to the third medium identification information sequentially in order of closeness to the root from the one having the closest folder to the root as a starting point.

Next, the medium identification information comparison unit 107 then determines whether or not third medium identification information ID3[n] identified by index n is present in the new medium management information 145#1 (S22). If such third medium identification information is present (S22: Yes), the medium identification information comparison unit 107 proceeds to step S23 and proceeds, and if such third medium identification information is not present (S22: No), it proceeds to step S27.

In step S23, the medium identification information comparison unit 107 determines whether or not the third medium identification information ID3[n] identified by index n and the third medium identification information included in the previous medium management information 145#2 agree with each other. If they agree with each other (S23: No), the medium identification information comparison unit 107 proceeds to step S24, and if they do not agree (S23: No), it proceeds to step S25.

In step S24, the medium identification information comparison unit 107 determines that the folder designated as the starting point for the third medium identification information ID[n] is a valid folder.

On the other hand, in step S25, the medium identification information comparison unit 107 determines that the folder designated as the starting point for the third medium identification information ID[n] is an invalid folder.

Next, the medium identification information comparison unit 107 adds ‘1’ to index n (S26) and returns to step S22.

If it is determined in step S22 that the third medium identification information ID3[n] is not present (S22: No), the processing proceeds to step S27.

In step S27, the tag management information update unit 113 determines whether the folder (root) that have been determined as being an invalid folder is present. If such folder is present (S27: Yes), the tag management information update unit 113 proceeds to step S28, and if no such folder is present (S27: No), it proceeds to step S30.

In step S28, the tag management information update unit 113 analyzes again the tag information of a content file placed immediately under the folder (root) which has been determined as being an invalid folder.

On the basis of the result of the analysis, the tag management information update unit 113 updates the tag management information (S29). At this time, if the same file name is stored in the E_Name column 140b of the entry management information 140 and the E_Name column 141c of the master management information 141, the tag management information update unit 113 updates the entry number stored in the E_No column 141b of the master management information 141 so that the entry number stored in the E_No column 140a of the entry management information 140 may agree with the entry number stored in the E_No column 141b of the master management information 141.

On the other hand, in step S30, the tag information analysis unit 108 determines that the inserted recording medium is the one inserted for the first time and analyzes the tag information on the basis of data read from the recording medium by the data readout unit 103. On the basis of the result of the analysis, the tag management information generation unit 109 generates the tag management information. The generated tag management information is stored in the data storage unit 111, through the data processing unit 110.

Next, the medium identification information comparison unit 107 updates the medium management information by causing the data storage unit 111 to store new medium management information 145#1 (S31).

In the first embodiment, the tag management information is recorded in the data storage unit 111 after the analysis of the tag information of all the content files is completed, but timing of the recording is not limited to that. The tag management information may be recorded temporarily in the data storage unit 111 in the middle of the analysis of the tag information. The timing of the recording may be delayed in accordance with a state of load, that is, in a case where the processing load on the reproduction apparatus 100 is heavy, for example.

When the file information analysis unit 104 and tag information analysis unit 108 analyze files on a recording medium, the file information analysis unit 104 and tag information analysis unit 108 may list and analyze just the files to be reproduced on the reproduction apparatus 100. The file information analysis unit 104 excludes the files that are not going to be reproduced from the entry management information 140, and the tag information analysis unit 108 does not need to analyze the tag information of the files that are not going to be reproduced. By doing so, the storage capacity can be saved and even if any other text files that make no difference with the tag information are added or deleted, it will not affect validity determination of the tag information. Whether a file is going to be reproduced or not can be determined by an extension of the file, for example.

The medium identification information is composed of the first medium identification information generated from the general hierarchical structure of data, the second medium identification generated from a content file stored immediately under the root, and the third medium identification information generated from data under a folder below the root, but if the recording medium has no folders, just the first medium identification information is calculated consequently.

In the first embodiment, an example of using the ID3 tag of the MP3 file has been described, but the file format and tag information format are not limited to them; files of a variety of formats may be used, and the tag information of any format that can be obtained from those files may be used. If necessary information is not described in an item of the tag information, a process of leaving the column corresponding to the item blank in the tag management information or a process to fill the corresponding column with a different character string may be performed. If genre information is not described, it may be filled with a character string such as ‘No Genres’, for example. In other words, even if no information is described in part of any items of the tag information, the present invention will produce effects by processing the tag information according to a unified processing rule.

The data storage unit 111 in the first embodiment is disposed in the reproduction apparatus 100, but it may be disposed physically outside the reproduction apparatus 100. For example, an external device of the reproduction apparatus 100, such as an external hard disk drive connected by a USB interface and a flash memory connected through a card slot, may be used as the data storage unit 111. In this embodiment, the medium management information 145 and tag management information may be stored somewhere other than the recording medium the user uses to store the content file.

The file information analysis and tag information analysis of a recording medium should preferably be carried out when the recording medium is inserted, but the timing is not limited to that. Depending on the function configuration of the reproduction apparatus 100 and the processing capability of the reproduction apparatus 100, the analysis may be carried out at any timing after that. For example, if the reproduction apparatus 100 has an apparatus configuration that allows both a USB memory and an SD memory card to be inserted concurrently, when the USD memory and the SD memory card are inserted at substantially the same time, the reproduction apparatus 100 may first analyze one of the two, e.g., the USB memory, and then analyze the other, e.g., the SD memory card.

As for reproduction start timing of the recording medium, the reproduction does not need to start after the analysis of all the tag information is completed. When the entry management information 140 is generated on the basis of the result of the analysis by the file information analysis unit 104, the reproduction may start in order in which the entries are listed in the entry management information 140, and the tag information may be analyzed concurrently by the tag information analysis unit 108.

In the first embodiment, an example of applying the present invention to the video or audio reproduction apparatus 100 has been described, but the present invention may also be applied to a reproduction apparatus for still images taken by a digital camera, for example.

Since the first medium identification information, second medium identification information, and third medium identification are used in the first embodiment, even if a content file or the hierarchical structure is changed, the tag management information can be updated by analyzing again the tag information of a part which is likely to have been changed. If the first medium identification information does not match and all the third medium identification information matches, it can be determined that a content file immediately under the root has been changed, and therefore the second medium identification information may be omitted.

As described above, the first embodiment stores a combination of the tag management information of a result of the tag information analysis and the medium management information 145 generated on the basis of a result of the file information analysis in the reproduction apparatus 100, and compares the medium identification information included in the medium management information 145 to determine whether the tag information is valid when a recording medium is inserted; so it can manage the tag information without reducing a storage capacity of the recording medium used by the user. Therefore, the reproduction apparatus 100 can generate a list of content files of a large amount of content to display the list, and reproduce the content selected according to the list quickly.

As a result of evaluation of a conventional apparatus using a USB memory storing 100 music content files, when the content files were opened one by one to analyze their tag information, the analysis process took about 12 seconds. However, when the reproduction apparatus 100 according to the first embodiment compared the medium identification information, using the medium management information 145, for the recording medium on which the corresponding tag management information has already been recorded, and read the tag management information recorded in the data storage unit 111, a list can be created within one second.

In the reproduction apparatus 100 according to the first embodiment, even if the first medium identification information does not match the one in the previous medium management information 145, validity of the tag information can be determined partially on the basis of the second medium identification information and the third medium identification information, and the tag information can be updated partially in a necessary range; so, even if only part of content on the recording medium has been rewritten, the tag information analysis can be completed quickly.

In the reproduction apparatus 100 according to the first embodiment, by comparing the third medium identification information successively in descending order of layers, if any of the folders is rewritten, for example, the validity of the tag information can be determined through a fewer determination steps.

In the reproduction apparatus 100 according to the first embodiment, the first medium identification information, second medium identification information, and third medium identification include the entry names; so, even if the number of contents remains unchanged between before and after the content on a recording medium is replaced, a misjudgment of determining that the recording medium is the same as a previously inserted one can be avoided.

In the reproduction apparatus 100 according to the first embodiment, the first medium identification information, second medium identification information, and third medium identification include the update dates and times of the content files; so, even if a content file is updated, e.g., even if an artist name or the like is updated by the user, a misjudgment of determining that the recording medium is the same as the a previously inserted one can be avoided. Therefore, the tag information of such content file is analyzed again, and correct information is obtained.

In the reproduction apparatus 100 according to the first embodiment, the first medium identification information and second medium identification information include the entry number of an upper layer; so, even if a position of a folder is changed, the recording medium can be determined as being different from a previously inserted one. Furthermore, if a content file is deleted once and written again in the same layer, the recording medium can be determined as being the same as the previously inserted one.

In the reproduction apparatus 100 according to the first embodiment, since the medium management information 145 and tag management information are stored in the reproduction apparatus 100, even if writing is not permitted to user's recording medium, a list display and so on can be quickly performed by using the tag information that was generated previously.

### Second Embodiment

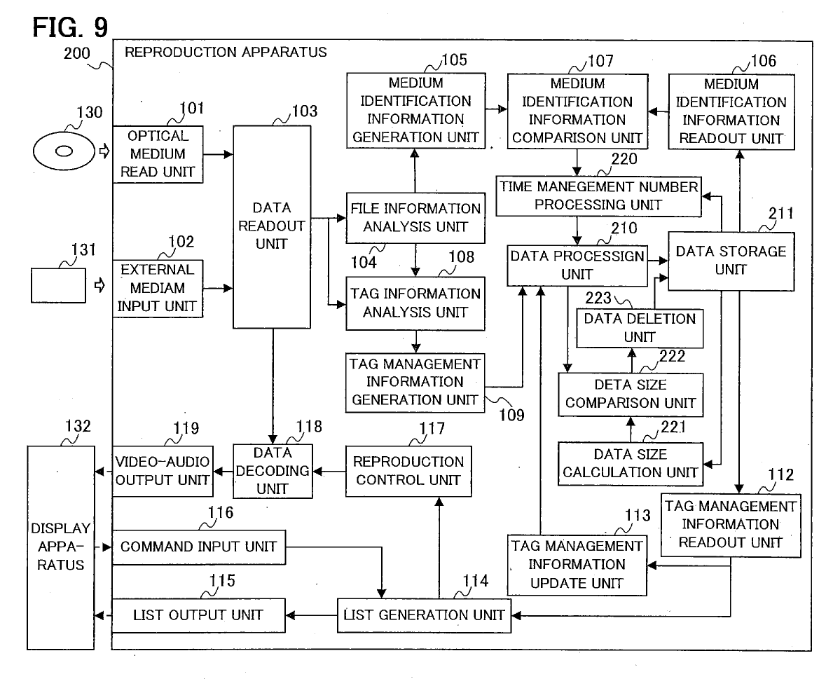

FIG. 9 is a block diagram schematically showing a configuration of a reproduction apparatus 200 as an information processing device according to a second embodiment. The reproduction apparatus 200 includes an optical medium read unit 101, an external medium input unit 102, a data readout unit 103, a file information analysis unit 104, a medium identification information generation unit 105, a medium identification information readout unit 106, a medium identification information comparison unit 107, a tag information analysis unit 108, a tag management information generation unit 109, a data processing unit 210, a data storage unit 211, a tag management information readout unit 112, a tag management information update unit 113, a list generation unit 114, a list output unit 115, a command input unit 116, a reproduction control unit 117, a data decoding unit 118, a video-audio output unit 119, a time management number processing unit 220, a data size calculation unit 221, a data size comparison unit 222, and a data deletion unit 223. The reproduction apparatus 200 according to the second embodiment differs from the reproduction apparatus 100 according to the first embodiment in terms of processing in the data processing unit 210, information stored in the data storage unit 211, and in that the time management number processing unit 220, data size calculation unit 221, data size comparison unit 222, and data deletion unit 223 are further included. In the reproduction apparatus 200 according to the second embodiment, multiple pieces of the medium management information 145 and multiple pieces of the tag management information can be stored in the data storage unit 211.

Each time the medium management information 145 generated by the medium identification information generation unit 105 is accumulated in the data storage unit 211, the time management number processing unit 220 assigns to that medium management information 145 a time management number indicating that the time of access is the latest (it has been accessed most recently). In other words, the time management number indicates newness of the time of access to the medium management information 145.

The data processing unit 210 performs the same processing as in the first embodiment and has the data storage unit 211 store the time management number assigned to the medium management information 145 by the time management number processing unit 220 in association with the medium management information 145 when the medium management information 145 is stored in the data storage unit 211.

When the data processing unit 210 has the data storage unit 211 store data, it checks whether or not the data storage unit 211 can store the data and then has the data storage unit 211 store the data. In the second embodiment, multiple pieces of the medium management information 145 and multiple pieces of tag management information are stored in the data storage unit 211, so the size of data stored in the data storage unit 211 increases. Since the recording capacity of the data storage unit 211 is finite, a data deletion process becomes necessary.

The data storage unit 211 stores the medium management information 145 and tag management information as in the first embodiment and also stores the time management number generated by the time management number processing unit 220 in association with the medium management information 145.

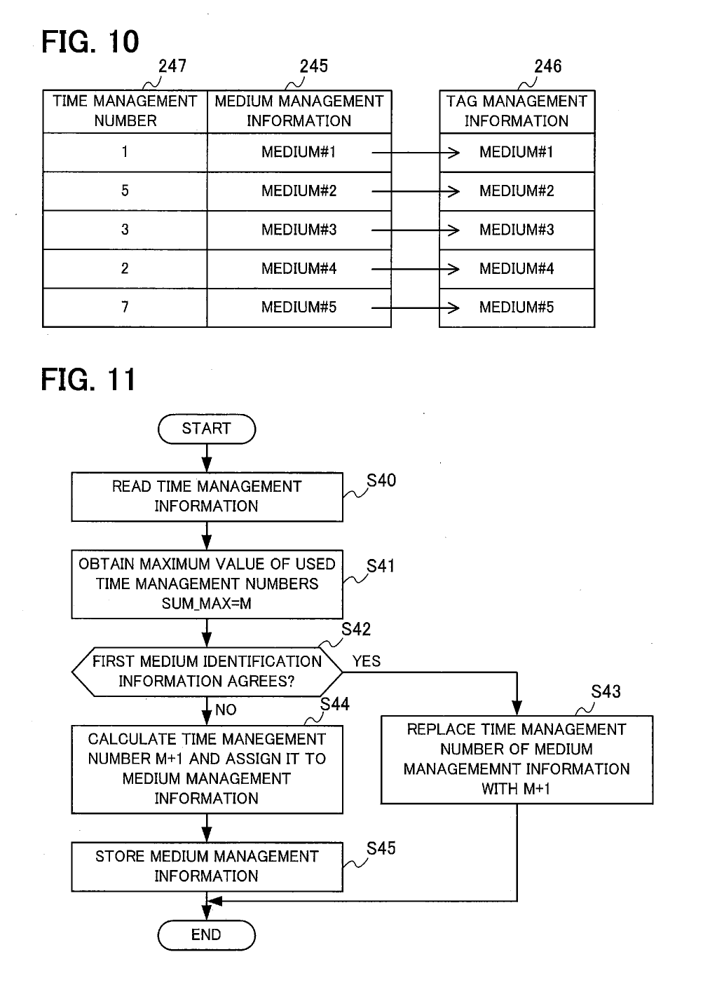

FIG. 10 is a schematic diagram showing information stored in the data storage unit 211. In FIG. 10, a reference numeral 245 denotes a medium management information group including multiple pieces of medium management information 145. A reference numeral 246 denotes a tag management information group including multiple pieces of tag management information. The medium management information 145 and tag management information is associated in accordance with the recording medium on which the respective information is generated. A reference numeral 247 denotes time management information including time management numbers associated with the corresponding pieces of the medium management information 145 included in the medium management information group 245. As the time management number increases, the time of the access to the medium management information 145 associated with the time management number is closer to the current time.

The data size calculation unit 221 calculates the remaining recording capacity of the data storage unit 211. The data size calculation unit 221 calculates the remaining recording capacity by subtracting the amount of data stored in the data storage unit 211 from the maximum recording capacity (storage capacity) of the data storage unit 211, for example.

The data size comparison unit 222 compares the size of data to be stored in the data storage unit 211 and the remaining recording capacity calculated by the data size calculation unit 221, the size of data being reported from the data processing unit 210. If the data size is equal to or less than the remaining recording capacity, the data size comparison unit 222 supplies the data processing unit 210 with a permission notice indicating permission to record data in the data storage unit 211. If the data size is more than the remaining recording capacity, the data size comparison unit 222 supplies the data deletion unit 223 with a delete command to delete data from the data storage unit 211.

In accordance with the command from the data size comparison unit 222, the data deletion unit 223 deletes data from the data storage unit 211. For example, the data deletion unit 223 deletes from the data storage unit 211 the medium management information and tag management information having the smallest time management number, that is, the oldest time of access, for example.

FIG. 11 is a flowchart illustrating a process to update the time management number in the second embodiment.

First, on obtaining the medium management information 145 from the medium identification information comparison unit 107, the time management number processing unit 220 reads the time management information 247 from the data storage unit 211 (S40) and extracts the maximum value (Sum_MAX) of the time management numbers which have already been used (S41).

The time management number processing unit 220 then determines whether or not in the medium identification information comparison unit 107, agreement occurs as a result of the comparison of the first medium identification information of the medium management information 145 obtained from the medium identification information comparison unit 107 (S42). The time management number processing unit 220 can make the determination by obtaining necessary information from the medium identification information comparison unit 107. If it is determined that the agreement between them occurs (S42: Yes), the time management number processing unit 220 proceeds to step S43, and if it is determined that the agreement between them does not occur (S43: No), it proceeds to step S44.

In step S43, the time management number processing unit 220 replace, with the value (Sum_MAX+1) obtained by adding ‘1’ to the maximum value in step S41, the time management number of the medium management information 145 identified as its first medium identification information being equal in step S42, among the medium management information 145 already stored in the data storage unit 211.

In step S44, the time management number processing unit 220 assigns a time management number indicating the value (Sum_MAX+1) obtained by adding ‘1’ to the maximum value in step S41, to the medium management information 145 obtained from the medium identification information comparison unit 107.

The time management number processing unit 220 then supplies the data processing unit 210 with the medium management information 145 obtained from the medium identification information comparison unit 107 and the time management number assigned in step S44, and the data processing unit 210 has the data storage unit 211 store the two in association (S45).

Referring to the flowchart shown in FIG. 11, when the medium management information 145 of recording medium #1 inserted for the first time is generated, for example, the time management number processing unit 220 assigns it a time management number ‘1’. When recording medium #2, which differs from recording medium #1, is inserted, the time management number processing unit 220 assigns the value ‘2’ obtained by adding ‘1’ to the currently used maximum value ‘1’ to the medium management number 145 of recording medium #2. When recording medium #1 is inserted again without any change to the content files and hierarchical structure, since it is determined that the medium management information 145 and tag management information stored in the data storage unit 211 are in the latest states, the corresponding information is not updated, but the time management number processing unit 220 replaces the time management number of recording medium #1 with ‘3’ obtained by adding ‘1’ to the currently used maximum value ‘2’. When new recording medium #3 is inserted next, the time management number processing unit 220 assigns the value ‘4’ by adding ‘1’ to the currently used maximum value ‘3’ as the time management number of the medium management information 145. In that way, the time management numbers are updated in such an ascending order that the recording medium having an older time of access is assigned a smaller time management number.

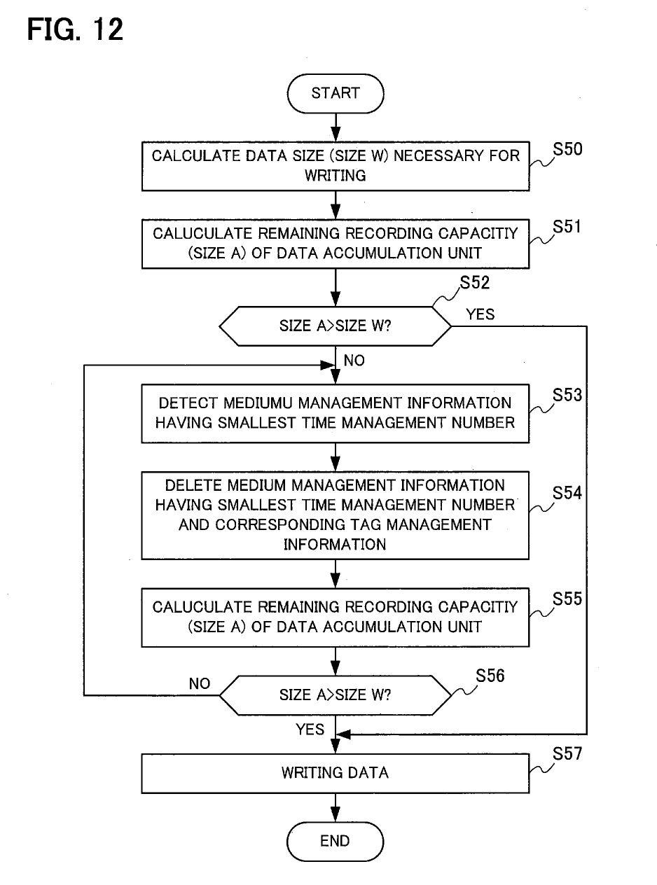

FIG. 12 is a flowchart illustrating processing performed to store data in the data storage unit 211 in the second embodiment.

Before having the data storage unit 211 store data, the data processing unit 210 calculates the size (Size W) of the data to be written (S50) and notifies the data size comparison unit 222 of the calculated data size.

Receiving the notification, the data size comparison unit 222 has the data size calculation unit 221 calculate the remaining recording capacity (Size A) of the data storage unit 111 (S51).

The data size comparison unit 222 compares the data size (Size W) from the data processing unit 210 with the remaining recording capacity (Size A) calculated by the data size calculation unit 221 to check whether or not the remaining recording capacity (Size A) is larger than the data size (Size W) (S52). If the remaining recording capacity (Size A) is equal to or less than the data size (Size W) (S52: No), the data size comparison unit 222 proceeds to step S53, and the remaining recording capacity (Size A) is larger than the data size (Size W) (S52: Yes), it proceeds to step S57.

In step S53, the data size comparison unit 222 gives the data deletion unit 223 a delete command. Receiving the command, the data deletion unit 223 references the time management information 247 stored in the data storage unit 211 to find the medium management information 145 having the smallest time management number.

The data deletion unit 223 deletes the medium management information 145 having the smallest time management number and the tag management information corresponding to the medium management information 145 having the smallest time management number (S54).

The data size calculation unit 221 calculates again the remaining recording capacity (Size A) of the data storage unit 111 (S55).

The data size comparison unit 222 compares the data size (Size W) from the data processing unit 210 with the remaining recording capacity (Size A) calculated in step S55 to check whether or not the remaining recording capacity (Size A) is larger than the data size (Size W) (S56). If the remaining recording capacity (Size A) is equal to or less than the data size (Size W) (S56: No), the data size comparison unit 222 returns to step S53, and if the remaining recording capacity (Size A) is larger than the data size (Size W) (S52: Yes), it proceeds to step S57.

In step S57, the data size comparison unit 222 gives the data processing unit 210 a notice of permission. Receiving the notice of permission, the data processing unit 210 has the data storage unit 211 store the data.

If the time management numbers are assigned as described above, the time management number increases each time a recording medium is inserted; so the size of the variable for the time management number data should be determined according to consideration of the total number of times of insertion to the reproduction apparatus 200. If the number of the times of the insertion of the recording medium is ten times a day and if the insertion is repeated 365 days a year for ten years, the time management number would increase to about 36500, and the size to be allocated to the variable should be two bytes.

The time management number explained above is incremented by ‘1’ from the initial value ‘1’, but the number is not limited to that value. The time management number may be any value which is unique for the medium management information 145 and can indicate the newness of the time of the access.

In the reproduction apparatus 200 according to the second embodiment, since the data storage unit 211 stores the medium management information 145 and tag management information as far as the storage capacity permits, as for a storage medium the user has used previously, a selection list can be displayed quickly in accordance with the tag management information stored before.

In the reproduction apparatus 200 according to the second embodiment, since the medium management information 145 and tag management information is deleted in chronological order of the time of the access, the tag management information of a recording medium the user uses frequently is preferentially maintained. As for that kind of recording medium, a list can be displayed quickly.

### Third Embodiment

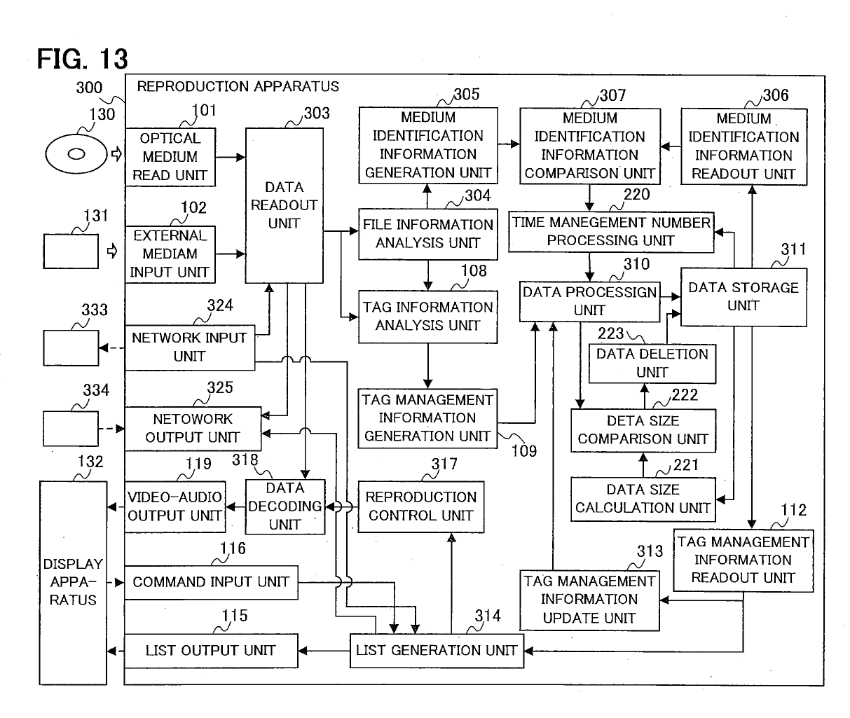

FIG. 13 is a block diagram schematically showing a configuration of a reproduction apparatus 300 as an information processing device according to a third embodiment. The reproduction apparatus 300 includes an optical medium read unit 101, an external medium input unit 102, a data readout unit 303, a file information analysis unit 304, a medium identification information generation unit 305, a medium identification information readout unit 306, a medium identification information comparison unit 307, a tag information analysis unit 108, a tag management information generation unit 109, a data processing unit 310, a data storage unit 311, a tag management information readout unit 112, a tag management information update unit 313, a list generation unit 314, a list output unit 115, a command input unit 116, a reproduction control unit 317, a data decoding unit 318, a video-audio output unit 119, a time management number processing unit 220, a data size calculation unit 221, a data size comparison unit 222, a data deletion unit 223, a network input unit 324, and a network output unit 325. The reproduction apparatus 300 according to the third embodiment differs from the reproduction apparatus 200 according to the second embodiment in terms of processing in the data readout unit 303, file information analysis unit 304, medium identification information generation unit 305, medium identification information readout unit 306, medium identification information comparison unit 307, data processing unit 310, tag management information update unit 313, list generation unit 314, reproduction control unit 317, and data decoding unit 318, in terms of information stored in the data storage unit 311, and in that the network input unit 324 and network output unit 325 are further included.

The data readout unit 303 performs the same processing as in the second embodiment and also obtains data placed immediately under each layer in the hierarchical structure of data stored in the first information processing device 333, that is, content files and layers (folders) placed immediately under each layer, as hierarchical data, when it obtains data from the first information processing device 333 through the network input unit 324.

The data readout unit 303 and network input unit 324 form a network data acquisition unit for acquiring data from the network.

The file information analysis unit 304 performs the same processing as in the second embodiment and also obtains the acquired hierarchical data from the data readout unit 303 when data are obtained from the first information processing device 333 through the network input unit 324. The file information analysis unit 304 analyzes the hierarchical data and generates hierarchical entry management information, which is the entry management information for each layer. The hierarchical entry management information corresponds to the information including, for each of layers, each entry stored as the entry management information 140 shown in FIG. 4. If the necessary content files and layers are all obtained from the first information processing device 333 through the network input unit 324, the file information analysis unit 304 collects all the hierarchical entry management information and generates collective entry management information.

The medium identification information generation unit 305 performs the same processing as in the second embodiment and also obtains the hierarchical entry management information from the file information analysis unit 304 when data are obtained from the first information processing device 333 through the network input unit 324. On the basis of the obtained hierarchical entry management information, the medium identification information generation unit 305 generates fourth medium identification information, which is the medium identification information of each layer. The fourth medium identification information is partial medium identification information identified at least either by the content file or by the layer placed immediately under the layer formed in the data recorded on the recording medium, in each predetermined part. In the third embodiment, the predetermined part is a part immediately under each layer. The fourth medium identification is, for example, the sum obtained by adding in units of bytes the information stored in the E_Name column and TimeStamp column of all the entries corresponding to the folders and content files included in the hierarchical entry management information.

When all the necessary data are obtained from the first information processing device 333 through the network input unit 324, the medium identification information generation unit 305 generates collective medium management information corresponding to medium management information generated by collecting all the fourth medium identification information. In that process, the medium identification information generation unit 305 may generate first medium identification information and store it in the collective medium management information. The medium identification information generation unit 305 supplies the collective medium management information to the data processing unit 310, and the data processing unit 310 has the data storage unit 311 store the collective medium management information.

If data are obtained through a network (not shown), it is assumed that the data transfer rate is generally insufficient in comparison with the optical medium read unit 101 directly connected to the reproduction apparatus 300 or the USB memory and the like connected to the external medium input unit 102. It may take time to analyze the hierarchical structure of a large amount of content. Accordingly, in the third embodiment, the fourth medium identification information is generated only for data in a single layer.

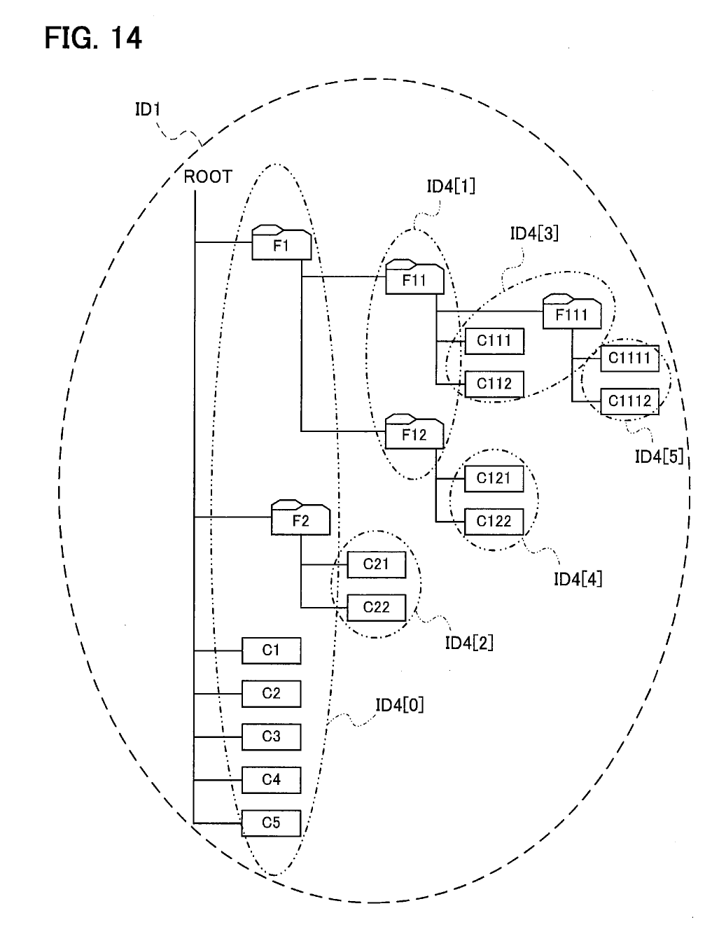

FIG. 14 is a schematic diagram showing ranges of entries used when fourth medium identification information is generated.

The generation range of the fourth medium identification information is limited to a single layer. Specifically, fourth medium identification information ID4[0] is generated from the content files and folders immediately under the root, or folders F1, F2 and content files C1 to C5. Fourth medium identification information ID4[1] is generated from the content files and folders immediately under folder F1, or folders F11 and F12. Fourth medium identification information ID4[2] is generated from the content files and folders immediately under folder F2, or content files C21 and C22. Fourth medium identification information ID4[3] is generated from the content files and folders immediately under folder F11, or folder F111 and content files C111 and C112. In that way, the ranges of fourth medium identification information ID4[4] and ID4[5] are also specified.

The medium identification information readout unit 306 performs the same processing as in the second embodiment and also reads the collective medium management information from the data storage unit 311 when data are obtained from the first information processing device 333 through the network input unit 324. If the medium management information 145 and the collective medium management information are not identified in the data storage unit 311, the medium identification information readout unit 306 reads the medium management information 145 and collective medium management information.

The medium identification information comparison unit 307 performs the same processing as in the second embodiment and also determines whether or not the fourth medium identification information generated by the medium identification information generation unit 305 is included in the medium management information 145 or the collective medium management information supplied from the medium identification information readout unit 306, when data are obtained from the first information processing device 333 through the network input unit 324. If the fourth medium identification information is included in the medium management information 145 or the collective medium management information, the medium identification information comparison unit 307 determines that the tag management information of the content file placed immediately under the layer is valid.

If the medium identification information comparison unit 307 determines that the tag management information of the content file placed immediately under a specific layer is valid, the list generation unit 314 obtains the tag information of the content file from the tag management information associated with the medium management information 145 or the collective medium management information which has included the fourth medium management information and generates a separate selection list by listing the obtained information.

The list generation unit 314 has the network output unit 325 output the generated separate selection list to the second information processing device 334.

The list generation unit 314 further generates a separate reproduction list indicating a content file corresponding to the user-selected information on the basis of the separate selection list. The list generation unit 314 supplies the separate reproduction list generated like that to the reproduction control unit 117.

The list generation unit 314 may generate the separate reproduction list by receiving input of user selection through the list output unit 115 and command input unit 116 as in the first embodiment.

The reproduction control unit 317 performs the same processing as in the second embodiment and also identifies a content file from the collective entry management information generated by the file information analysis unit 304 in accordance with the command given by the user on the basis of the separate reproduction list and has the data readout unit 303 output the identified content file through the network output unit 325 to the second information processing device 334.

In that process, the reproduction control unit 317 may send the identified content file from the data readout unit 303 to the data decoding unit 318 and output the decoded video signal and audio signal through the network output unit 325 to the second information processing device 334.

The reproduction control unit 317 may also send the identified content file from the data readout unit 303 to the data decoding unit 318 and output the video signal and audio signal through the video-audio output unit 119 to the display apparatus 132, as in the first embodiment.

The network input unit 324 is an interface unit for receiving data from the first information processing device 333 connected through a network (not shown). The first information processing device 333 is, for example, a storage device such as NAS (network attached storage) placed on a network or another video-audio storage device such as MOST (media oriented systems transport) connected by a network or the like.

The network output unit 325 is an interface unit that sends the separate selection list generated by the list generation unit 314 through the network to the second information processing device 334 and also sends the video signal and audio signal decoded by the data decoding unit 318 or the encoded data (content file) read from the data readout unit 303 through the network to the second information processing device 334.

The tag management information update unit 313 performs the same processing as in the second embodiment and, if part of the fourth medium identification information does not agree, when data are obtained from the first information processing device 333 through the network input unit 324, also analyzes the tag information of the content file placed immediately under the layer and updates the tag management information.

In the third embodiment, when data are obtained from the first information processing device 333 through the network input unit 324, the tag information analysis unit 108 should analyze the tag information after the data readout unit 303 obtains all necessary data through the network input unit 324.

In the reproduction apparatus 300 according to the third embodiment, the fourth medium identification information is generated by the layer for the recording medium connected through the network, and the amount of data obtained through the network can be reduced. Even when the data transfer band is insufficient, part of the tag management information previously recorded in the data storage unit 311 is determined as being valid tag management information, and a list based on the tag management information can be presented to the user quickly by using the recording medium connected through the network.

In the embodiments described above, layers are formed by folders, but the layers may also be formed by directories.

### REFERENCE CHARACTERS

100, 200, 300 reproduction apparatus, 101 optical medium read unit, 102 external medium input unit, 103, 303 data readout unit, 104, 304 file information analysis unit, 105, 305 medium identification information generation unit, 106, 306 medium identification information readout unit, 107, 307 medium identification information comparison unit, 108 tag information analysis unit, 109 tag management information generation unit, 110, 210, 310 data processing unit, 111, 211, 311 data storage unit, 112 tag management information readout unit, 113, 313 tag management information update unit, 114, 314 list generation unit, 115 list output unit, 116 command input unit, 117 reproduction control unit, 118, 318 data decoding unit, 119 video-audio output unit, 220 time management number processing unit, 221 data size calculation unit, 222 data size comparison unit, 223 data deletion unit, 324 network input unit, 325 network output unit, 130 optical medium, 131 external medium, 333 first information processing device, 334 second information processing device.

1. An information processing device comprising:
a data storage unit which stores attribute management information for managing attribute information of a content file included in data recorded on a recording medium which has been used previously and, for each predetermined part, medium management information including partial medium identification information identified by at least one of a layer and a content file placed immediately under a layer formed in the data recorded on the previously used recording medium;
a data acquisition unit which acquires data from a recording medium which is used currently;
a file information analysis unit which analyzes the data acquired by the data acquisition unit and generates entry management information which indicates a layer formed in the acquired data and at least one of a content file and a layer placed immediately under the layer formed in the acquired data;
a medium identification information generation unit which generates, for each predetermined part, partial medium identification information identified by at least one of the content file and the layer placed immediately under the layer formed in the data acquired by the data acquisition unit, from the entry management information;
a medium identification information comparison unit which compares the partial medium identification information included in the medium management information and the partial medium identification information generated by the medium identification information generation unit; and
an attribute management information update unit which updates the attribute management information on the basis of the attribute information of the content file included in the predetermined part for which the medium identification information generation unit has generated the partial medium identification information determined as being not equal to the partial medium identification information stored in the data acquisition unit in accordance with a result of the comparison by the medium identification information comparison unit.

2. The information processing device of claim 1, further comprising:
a list generation unit which generates a selection list for selecting content to be reproduced on the basis of the attribute management information updated by the attribute management information update unit.

3. The information processing device of claim 1, wherein the partial medium identification information is generated by using at least one of identification information for identifying a layer included in the predetermined part and identification information for identifying a content file placed in the layer included in the predetermined part and time of update of the content file placed in the layer included in the predetermined part.

4. The information processing device of claim 1, wherein:
the medium management information further includes general medium identification information identified by all layers formed in the data recorded on the previously used recording medium and the content files placed immediately under all the layers formed in the data recorded on the previously used recording medium;
the medium identification information generation unit further generates general medium identification information identified by all layers formed in the data acquired by the data acquisition unit and the content files placed immediately under all the layers formed in the data acquired by the data acquisition unit, from the entry management information; and
the medium identification information comparison unit compares the general medium identification information included in the medium management information and the general medium identification information generated by the medium identification information generation unit and, if a result of the comparison indicates agreement, does not compare the partial medium identification information included in the medium management information and the partial medium identification information generated by the medium identification information generation unit.

5. The information processing device of claim 4, wherein the general medium identification information is generated by using identification information for identifying each one of all the layers, identification information for identifying a layer that is one layer higher than each one of all the layers, identification information for identifying a content file placed immediately under each one of all the layers, identification information for identifying a layer that is one layer higher than the content file placed immediately under each one of all the layers, and date and time of update of the content file placed immediately under each one of all the layers.

6. The information processing device of claim 1, wherein the attribute management information includes item management information including information corresponding to an item included in the attribute information and master management information for associating the content file and the information included in the item management information.

7. The information processing device of claim 1, wherein the data storage unit stores the attribute management information and the medium management information in association with each other for each of a plurality of recording media which have been used previously.

8. The information processing device of claim 7, wherein the data storage unit further stores a time management number indicating newness of time of access for each piece of the medium management information, and the information processing device further comprising:
a data size calculation unit which calculates a remaining recording capacity of the data storage unit;
a data size comparison unit which compares data size of data to be newly stored in the data storage unit and the remaining recording capacity; and
a data deletion unit which deletes the medium management information which has the oldest time indicated by the time management number and the attribute management information corresponding to the medium management information which has the oldest time, when the result of the comparison by the data size comparison unit indicates that the data size is larger than the remaining recording capacity.

9. The information processing device of claim 1, wherein the predetermined part is, for each of the layers, a part immediately under each of the layers and a part immediately under all the layers below each of the layers.

10. The information processing device of claim 1, wherein the predetermined part is a part immediately under each layer.

11. An information processing device comprising:
a data storage unit which stores attribute management information for managing the attribute information of a content file included in data recorded on a recording medium which has been used previously and, for each predetermined part, medium management information including partial medium identification information identified by at least one of a layer and a content file placed immediately under a layer formed in the data recorded on the recording medium which has been used previously;
a data acquisition unit which acquires data from a recording medium which is used currently;
a file information analysis unit which analyzes the data acquired by the data acquisition unit and generates entry management information which indicates a layer formed in the acquired data and at least one of a layer and a content file placed immediately under the layer formed in the acquired data;
a medium identification information generation unit which generates, for each predetermined part, partial medium identification information identified by at least one of the layer and the content file placed immediately under the layer formed in the data acquired by the data acquisition unit, from the entry management information; and
a medium identification information comparison unit which compares the partial medium identification information included in the medium management information and the partial medium identification information generated by the medium identification information generation unit.

12. The information processing device of claim 11, further comprising an attribute management information update unit which updates the attribute management information based on the result of the comparison by the medium identification information comparison unit.

13. An information processing method comprising:
a data storage step of storing attribute management information for managing attribute information of a content file included in data recorded on a recording medium which has been used previously and, for each predetermined part, medium management information including partial medium identification information identified by at least one of a layer and a content file placed immediately under a layer formed in the data recorded on the recording medium which has been used previously;
a data acquisition step of acquiring data from a recording medium which is used currently;
a file information analysis step of analyzing the data acquired in the data acquisition step and generating entry management information which indicates a layer formed in the acquired data and at least one of a content file and a layer placed immediately under the layer formed in the acquired data;
a medium identification information generation step of generating, for each predetermined part, partial medium identification information identified by at least one of the content file and the layer placed immediately under the layer formed in the data acquired in the data acquisition step, from the entry management information;
a medium identification information comparison step of comparing the partial medium identification information included in the medium management information and the partial medium identification information generated in the medium identification information generation step; and
an attribute management information update step of updating the attribute management information on the basis of the attribute information of the content file included in the predetermined part for which the medium identification information generation step has generated the partial medium identification information determined as being not equal to the partial medium identification information stored in the data acquisition step in accordance with a result of the comparison in the medium identification information comparison step.

14. The information processing method of claim 13, further comprising:
a list generation step of generating a selection list for selecting content to be reproduced on the basis of the attribute management information updated in the attribute management information update step.

15. The information processing method of claim 13, wherein the partial medium identification information is generated by using at least one of identification information for identifying a layer included in the predetermined part and identification information for identifying a content file placed in the layer included in the predetermined part and time of update of the content file placed in the layer included in the predetermined part.

16. The information processing method of claim 13, wherein:
the medium management information further includes general medium identification information identified by all layers formed in the data recorded on the previously used recording medium and the content files placed immediately under all the layers formed in the data recorded on the previously used recording medium;
in the medium identification information generation step, general medium identification information identified by all layers formed in the data acquired in the data acquisition step and the content files placed immediately under all the layers formed in the data acquired in the data acquisition step is generated further from the entry management information; and
in the medium identification information comparison step, the general medium identification information included in the medium management information is compared with the general medium identification information generated in the medium identification information generation step and, if a result of the comparison indicates that the information is equal, the partial medium identification information included in the medium management information is not compared with the partial medium identification information generated by the medium identification information generation step.

17. The information processing method of claim 16, wherein the general medium identification information is generated by using identification information for identifying each one of all the layers, identification information for identifying a layer that is one layer higher than each one of all the layers, identification information for identifying a content file placed immediately under each one of all the layers, identification information for identifying a layer that is one layer higher than the content file placed immediately under each one of all the layers, and date and time of update of the content file placed immediately under each one of all the layers.

18. The information processing method of claim 13, wherein the attribute management information includes item management information including information corresponding to an item included in the attribute information and master management information for associating the content file and the information included in the item management information.

19. The information processing method of claim 13, wherein in the data storage step the attribute management information and the medium management information is stored in association with each other for each of a plurality of recording media which have been used previously.

20. The information processing method of claim 19, wherein a time management number indicating newness of time of access is further stored for each piece of the medium management information in the data storage step, and the information processing method further comprising:
a data size calculation step of calculating a remaining recording capacity in the data storage step;
a data size comparison step of comparing data size of data to be newly stored in the data storage step and the remaining recording capacity; and
a data deletion step of deleting the medium management information which has the oldest time indicated by the time management number and the attribute management information corresponding to the medium management information which has the oldest time, when the result of the comparison in the data size comparison step indicates that the data size is larger than the remaining recording capacity.

21. The information processing method of claim 13, wherein the predetermined part is, for each of the layers, a part immediately under the each of the layers and a part immediately under all the layers below the each of the layers.

22. The information processing method of claim 13, wherein the predetermined part is a part immediately under each layer.

23. An information processing method comprising:
a data storage step of storing attribute management information for managing the attribute information of a content file included in data recorded on a recording medium which has been used previously and, for each predetermined part, medium management information including partial medium identification information identified by at least one of a layer and a content file placed immediately under a layer formed in the data recorded on the recording medium which has been used previously;
a data acquisition step of acquiring data from a recording medium which is used currently;
a file information analysis step of analyzing the data acquired in the data acquisition step and generating entry management information which indicates a layer formed in the acquired data and at least one of a layer and a content file placed immediately under the layer formed in the acquired data;
a medium identification information generation step of generating, for each predetermined part, partial medium identification information identified by at least one of the layer and the content file placed immediately under the layer formed in the data acquired by the data acquisition step, from the entry management information; and
a medium identification information comparison step of comparing the partial medium identification information included in the medium management information and the partial medium identification information generated by the medium identification information generation step.

24. The information processing method of claim 23, further comprising an attribute management information update step which updates the attribute management information based on the result of the comparison by the medium identification information comparison step.
